(19) United States
(12) Patent Application Publication
(10) Pub. No.: US 2014/0067620 A1
(43) Pub. Date: Mar. 6, 2014

(54) TECHNIQUES FOR PURCHASING BY CREDITING A MERCHANT'S CARD

(71) Applicant: Mikhail Blinov, Dun Laoghaire (IE)

(72) Inventor: Mikhail Blinov, Dun Laoghaire (IE)

(73) Assignee: MasterCard International Incorporated, Purchase, NY (US)

(21) Appl. No.: 13/600,365

(22) Filed: Aug. 31, 2012

(51) Int. Cl. G06Q 30/06

(52) U.S. Cl. 705/26.82

(57) ABSTRACT

An indication that a consumer wishes to check-out in connection with an on-line purchase of goods is obtained at a server of a merchant. Responsive to obtaining the indication, a total transaction amount, a credit-only payment card account number of the merchant, and a reference number assigned to the on-line purchase of goods are sent to the consumer. A guarantee that the consumer will cause the total transaction amount to be credited to the credit-only payment card account number of the merchant is obtained at the server of the merchant, from a bank of the merchant which issues the credit-only payment card account. The guarantee is associated with the reference number. Responsive to obtaining the guarantee, the goods are shipped to the consumer.

### FIELD OF THE INVENTION

The present invention relates generally to electronic commerce, and, more particularly, to electronic payment systems.

### BACKGROUND OF THE INVENTION

Currently, if a consumer buys goods online with a credit or debit card, he or she has to give his or her full card details to the online merchant. The merchant carries out an authorization request for the stated amount, obtains an authorization response, and if this is affirmative, delivers the goods. The merchant obtains the stated amount via a clearing and settlement process.

Currently, banks deploy a variety of heuristic-based techniques to block abnormal behavior. These techniques seek to prevent improper use of the consumer's card details by unscrupulous merchants and/or third parties who have obtained the details in an improper manner.

In addition to credit and debit card functionality, electronic payment service providers are currently providing a variety of other services. One example is the provision of person-to-person payment services via mobile phone or the like.

### SUMMARY OF THE INVENTION

Principles of the present invention provide techniques for purchasing by crediting a merchant's card. An exemplary embodiment of a method, according to one aspect of the invention, includes obtaining, at a server of a merchant, an indication that a consumer wishes to check-out in connection with an on-line purchase of goods; responsive to obtaining the indication, sending to the consumer a total transaction amount, a credit-only payment card account number of the merchant, and a reference number assigned to the on-line purchase of goods; and obtaining, at the server of the merchant, from a bank of the merchant which issues the credit-only payment card account, a guarantee that the consumer will cause the total transaction amount to be credited to the credit-only payment card account number of the merchant. The guarantee is associated with the reference number. A further step includes, responsive to obtaining the guarantee, shipping the goods to the consumer.

Another exemplary embodiment of a method, according to another aspect of the invention, includes the step of, responsive to a consumer wishing to check-out in connection with an on-line purchase of goods from a merchant, receiving, at a computing device of the consumer, from the merchant, a total transaction amount, a credit-only payment card account number of the merchant, and a reference number assigned to the on-line purchase of goods. A further step includes dispatching, from the consumer, to a server of a bank of the consumer, an approval of payment to the merchant for the on-line purchase of goods, based on the total transaction amount, the credit-only payment card account number of the merchant, and the reference number assigned to the on-line purchase of goods.

Still another exemplary embodiment of a method, according to still another aspect of the invention, includes the steps of assigning to a merchant an account number of a credit-only payment card account; and obtaining, from a consumer's bank, a guarantee that the consumer will cause a total transaction amount of an on-line transaction to be credited to the credit-only payment card account number of the merchant. The guarantee is associated with a reference number of the on-line transaction. A further step includes dispatching the guarantee to the merchant.

An even further exemplary embodiment of a method, according to a still further aspect of the invention, includes the steps of providing to an issuing bank at least one payment card account number specially designated for association with a credit-only payment card account; intercepting a message sent over a payment processing network which attempts to debit an account associated with the credit-only payment card account number; and preventing the attempt to debit the account associated with the credit-only payment card account number, based on credit-only status of the credit-only payment card account.

Aspects of the invention contemplate the method(s) performed by one or more entities herein, as well as facilitating of one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a tangible computer readable recordable storage medium with computer usable program code for performing the method steps indicated stored thereon in a non-transitory manner. Furthermore, one or more embodiments of the invention or elements thereof can be implemented in the form of a system (or apparatus) including a memory and at least one processor that is coupled to the memory and operative to perform exemplary method steps (e.g., a server or other computing device, smart phone, or the like). Yet further, in another aspect, one or more embodiments of the invention or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein.

One or more embodiments of the invention can provide substantial beneficial technical effects, including, for example:
security is enhanced by reducing, and preferably eliminating, the chance that unscrupulous parties will obtain access to a consumer's full card details
this is done in a manner that does not require the consumer to carefully verify his or her credit card bill
security is also enhanced by reducing the chance that merchants will receive card details associated with lost or stolen cards; this also advantageously reduces the risk to the merchant of subsequently-challenged transactions
prevents merchant from taking more money from consumer's account either for current purchase or in the future.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows a general example of a payment system, which is an exemplary context within which one or more embodiments of the invention can be implemented;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers;

FIG. 3 is a block diagram of an exemplary computer system useful in one or more embodiments of the invention;

FIG. 4 is a block diagram and data flow diagram, in accordance with an aspect of the invention;

FIG. 5 is a software architecture diagram of software that may be employed by a consumer's bank, in accordance with an aspect of the invention;

FIG. 6 is a software architecture diagram of software that may be employed by a bank which issues a merchant's special “credit only” card account, in accordance with an aspect of the invention; and

FIG. 7 is a software architecture diagram of software that may be employed by a merchant, in accordance with an aspect of the invention

### DETAILED DESCRIPTION OF PREFERRED EMBODIMENTS

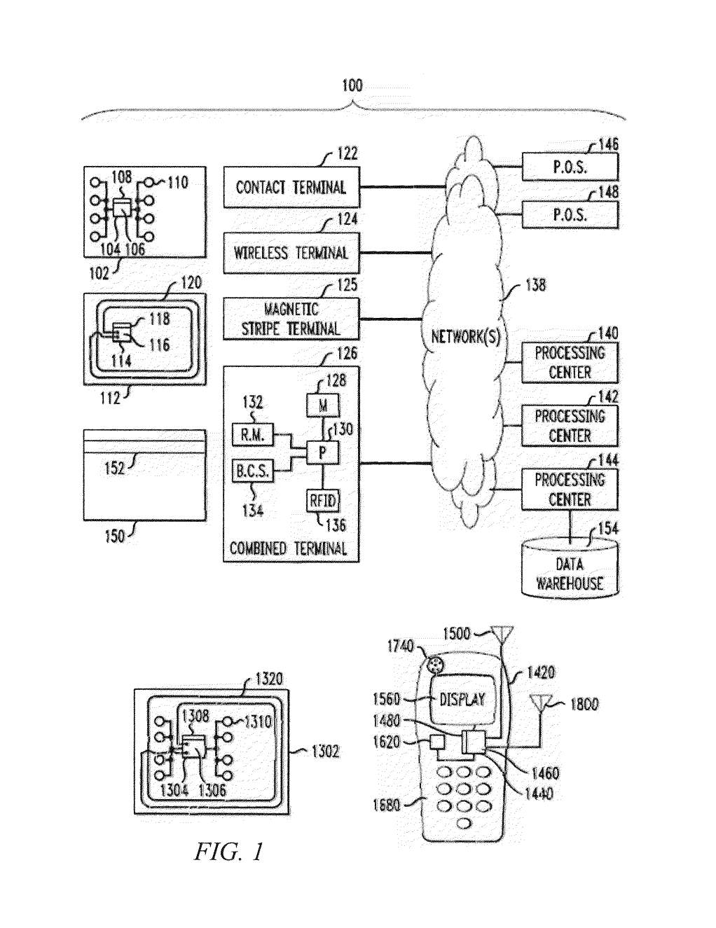

Attention should now be given to FIG. 1, which depicts an exemplary embodiment of a system 100, according to an aspect of the invention, and including various possible components of the system. It should be noted that one or more embodiments of the invention are directed to card-not-present Internet commerce. However, description of aspects of the system 100 involving presentation of a card or other payment device at a point of sale is also provided for completeness.

System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. The system per se may function with other types of devices in lieu of or in addition to “smart” or “chip” cards 102, 112; for example, a conventional card 150 having a magnetic stripe 152. Furthermore, an appropriately configured cellular telephone handset, personal digital assistant (PDA), and the like can be used to carry out contactless payments in some instances.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions or units 108, 118 can store the operating system of the cards 102, 112. The operating system loads and executes applications and provides file management or other basic card services to the applications. One operating system that can be used is the MULTOS® operating system licensed by MAOSCO Limited. (MAOSCO Limited, St. Andrews House, The Links, Kelvin Close, Birchwood, Warrington, WA3 7PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate approach, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

As noted, cards 102, 112 are examples of a variety of payment devices that can be employed. The primary function of the payment devices may not be payment, for example, they may be cellular phone handsets that implement aspects of the invention. Such devices could include cards having a conventional form factor, smaller or larger cards, cards of different shape, key fobs, personal digital assistants (PDAs), appropriately configured cell phone handsets, or indeed any device with the capabilities to implement aspects of the invention. In some cases, the cards, or other payment devices, can include body portions (e.g., laminated plastic layers of a payment card, case or cabinet of a PDA or cellular phone, chip packaging, and the like), memories 108, 118 associated with the body portions, and processors 106, 116 associated with the body portions and coupled to the memories. The memories 108, 118 can contain appropriate applications. The processors 106, 116 can be operative to facilitate execution of one or more method steps. The applications can be, for example, application identifiers (AIDs) linked to software code in the form of firmware plus data in a card memory such as an electrically erasable programmable read-only memory (EEPROM).

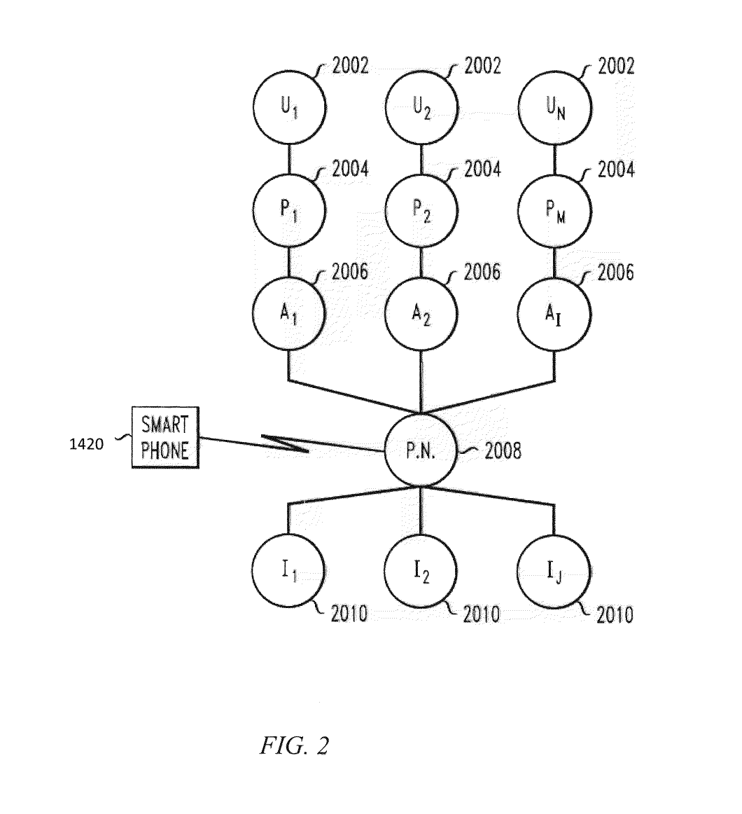

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can, in general, be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN) such as is described with respect to FIG. 2 below). More than one network could be employed to connect different elements of the system. For example, a local area network (LAN) could connect a terminal to a local server or other computer at a retail establishment. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. Different types of portable payment devices, terminals, or other elements or components can combine or “mix and match” one or more features depicted on the exemplary devices in FIG. 1. Again, one or more embodiments of the invention are directed to card-not-present Internet commerce.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps described herein. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 1420 (discussed below). The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices. In operation, card 112 can be touched or tapped on the terminal 124 or 128 (or an associated reader), which then contactlessly transmits the electronic data to the proximity IC chip in the card 112 or other wireless device.

One or more of the processing centers 140, 142, 144 can include a database such as a data warehouse 154.

A dual-interface device 1302 is sometimes employed. Device 1302 is shown larger than devices 102, 112 for illustrative convenience but can have a similar form factor. Device 1302 includes an IC chip 1304 having a processor portion 1306 and a memory portion 1308. A plurality of electrical contacts 1310, similar to contacts 110, can be provided, as well as an antenna 1320 similar to antenna 120, together with an oscillator or oscillators, and/or additional appropriate circuitry for one or more of modulation, demodulation, downconversion, and the like, as described with regard to device 112. Appropriate firmware to manage the two available interfaces can be provided, with operation otherwise being similar to devices 102, 112.

An appropriately configured cellular telephone handset 1420 can also be employed in a number of embodiments. Handset 1420 is depicted in semi-schematic form in FIG. 1, and can include one or more IC chips such as chip 1440 including a processing unit 1460 and a memory unit 1480. Wireless communication with a terminal can be provided via antenna 1500 or with a second antenna 1800 similar to above-described antenna 120 (i.e., the handset could have a second antenna for the payment application). Note that antenna 1800 is depicted schematically, but could be, e.g., a coil antenna as used in a typical “smart” card. Handsets 1420 can each be equipped with a suitable display 1560. Further, an appropriate power supply 1620 can also be provided. Such power supplies can include, for example, a battery and appropriate circuitry. The display and power supply can be interconnected with the processor portion. Different types of portable payment devices can combine or “mix and match” one or more features depicted on the exemplary devices in FIG. 1. Keypad 1680 and speaker 1740 can be provided. Many current devices omit keypad 1680 and employ a touchscreen instead; an emulation of a keypad is then provided on the touchscreen.

The description of devices, elements, or components 102, 104, 106, 108, 110, 112, 114, 116, 118, 120 throughout this document are equally applicable to the corresponding items in the dual interface card 1302 and cellular telephone handset 1420.

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, I₂ . . . I_{J}, through, for example, a single operator 2008 of a payment network configured to facilitate transactions between multiple issuers and multiple acquirers; for example, MasterCard International Incorporated, operator of the aforementioned BANKNET® network, or Visa International Service Association, operator of the aforementioned VISANET® network. In general, N, M, I, and J are integers that can be equal or not equal.

In some cases, network 2008 uses ISO 8583 messaging. ISO 8583, Financial transaction card originated messages—Interchange message specifications, is the International Organization for Standardization standard for systems that exchange electronic transactions made by cardholders using payment cards. It has three parts: Part 1: Messages, data elements and code values; Part 2: Application and registration procedures for Institution Identification Codes (IIC); and Part 3: Maintenance procedures for messages, data elements and code values, all of which are expressly incorporated herein by reference in their entirety for all purposes. The skilled artisan in the payments processing field will be thoroughly familiar with ISO 8583 in any case.

During a conventional credit authorization process, the cardholder 2002 pays for the purchase and the merchant 2004 submits the transaction to the acquirer (acquiring bank) 2006. The acquirer verifies the card number, the transaction type and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the credit card association, which debits the issuers 2010 for payment and credits the acquirer 2006. Once the acquirer 2006 has been paid, the acquirer 2006 pays the merchant 2004.

It will be appreciated that the network 2008 shown in FIG. 2 is an example of a payment network configured to facilitate transactions between multiple issuers and multiple acquirers, which may be thought of as an “open” system. In other instances, a payment network configured to facilitate transactions between multiple issuers and a single acquirer could be used. Some embodiments of the invention may be employed with other kinds of payment networks, for example, proprietary or closed payments networks with only a single issuer and acquirer.

As seen in FIG. 2, in some instances, the owner or user of a smart phone 1420 or similar device accesses a web site or the like of the payment network operator 2008 to download a suitable application to the phone 1420 or similar device. Note that the connection between phone 1420 and payment network operator 2008 may very well be indirect; for example, payment network operator 2008 may provide a “golden copy” of the application to a third party and phone 1420 downloads over the web from such third party. The link shown between phone 1420 and payment network operator 2008 also represents the flow of data between phone 1420 and payment network operator 2008, and may be direct or indirect; for example, via a cellular network and possibly with one or more intermediate parties.

One or more embodiments advantageously enable consumers to pay for goods by transferring money to a merchant's card instead of providing details of the consumer's card to the merchant. One or more instances employ credit-only cards to enable merchants to accept payments without exposure to risks.

As noted, currently, if a consumer buys goods online with a credit or debit card, he or she has to give his or her full card details to the online merchant. The merchant carries out an authorization request for the stated amount, obtains an authorization response, and if this is affirmative, delivers the goods. The merchant obtains the stated amount via a clearing and settlement process.

Currently, banks deploy a variety of heuristic-based techniques to block abnormal behavior. These techniques seek to prevent improper use of the consumer's card details by unscrupulous merchants and/or third parties who have obtained the details in an improper manner. While helpful, these techniques are far from perfect.

Advantageously, in one or more embodiments, the merchant is not provided with the details of the consumer's card. Therefore, the risk to the consumer of potential mis-use of his or her card is significantly reduced, and preferably eliminated, as compared with current techniques wherein the merchant obtains details of the consumer's card, as in such cases, the merchant (or someone else who managed to get access to these details at the merchant's site) can use the information to improperly and repeatedly take money from the consumer's account and/or to make purchases online that will be charged to the consumer's card.

Furthermore, also advantageously, in one or more embodiments, the consumer approves the purchase in a separate interaction with his or her bank, whereas in current techniques, the merchant is exposed to the risk that the card details he or she received were in fact stolen and, once discovered by the true card owner, the transaction will be challenged.

Even further, in one or more embodiments, protection against mis-use is inherent and review of credit card bills (although advisable in any case) is not necessarily required, whereas in most current approaches, the onus falls on consumers to carefully verify their credit card bills, which they rarely do.

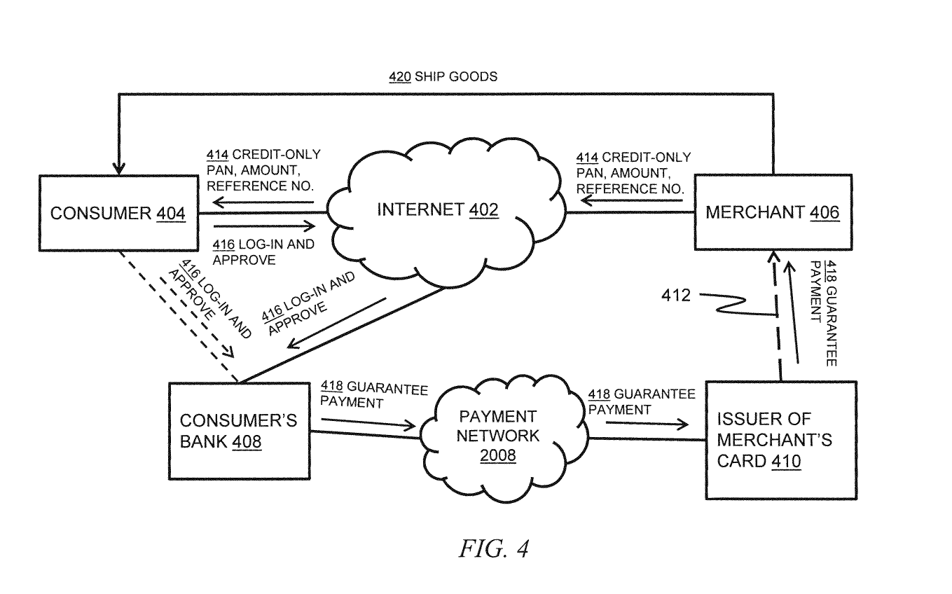

Reference should now be had to FIG. 4. In one or more embodiments, consumer 404 is enabled to pay for goods by transferring money to a special payment card account of the merchant 406. In one or more instances, merchant 406 has a special “credit only” payment card account. In this regard, it is important to note that in the context of payment cards, the terms “credit” and “debit” typically mean, in the former case, a card that allows a consumer to access a line of credit, and in the latter case, a card that allows a consumer to access his or her demand deposit account. On the other hand, in general usage, a “credit” is a balance in a person's favor in an account and a “debit” is a charge against a person's account. The term “credit” as to the “credit only” card account is used in this latter sense; that is to say, the “credit only” card account has all the properties of a normal card account except that it has a constraint that it can only be used for credit, not debit, transactions (i.e. transferring money to it, not taking money from it). It is therefore safe for the merchant to make the details of this “credit only” card account publicly available. Only the merchant can access the funds paid into the credit only account by the consumers; for example, the same may be placed in a normal bank account that the merchant has full access to, or there may be another card number (which may or may not be associated with a physical card) that functions in a conventional manner and allows the merchant to access the funds. For example, the PAN of the special credit only account that is given out to consumers might be 5491-XXXX-YYYY-1234; this number serves as a lock box which only allows incoming payments from consumers. These funds are accumulated, for example, in a bank account accessible via conventional withdrawals and/or via a debit card which has a different PAN, say, 5491-AAAA-BBBB-6789 which is not given out to consumers. Alternatively, the funds could be maintained as a server balance not associated with a conventional bank account and accessed via a stored balance type of card, which would also have a different PAN that that given out to the consumers.

There may or may not be a physical card or other physical payment device associated with the “credit only” card account. The issuer 410 of the merchant' credit only card account may send any physical card associated with it to the merchant by mail or the like, as illustrated by the dashed arrow 412. Alternatively, the issuer might simply provide the merchant with numerical details, via Internet 402 or otherwise. As used herein, an “internet” is a system of interconnected networks that results from the practice of connecting a computer network with other networks through the use of gateways that provide a common method of routing information packets between the networks; while the “Internet” (capitalized) is a global system of interconnected computer networks that use the standard Internet protocol suite to serve a very large number of users worldwide.

When a consumer 404 buys goods on the website of merchant 406 and navigates to the checkout page, instead of the consumer providing his or her card details to the merchant, the merchant gives the merchant's “credit only” card account number to the consumer together with the amount of the order and a reference number for the particular purchase. More specifically, the consumer 404 typically employs a browser program to access the web site of merchant 406 via Internet 402. The consumer selects one or more items to be purchased and places the item(s) in a virtual shopping cart. When done shopping, the user clicks on a check-out button or otherwise indicates that check-out is desired.

At this point, it is worth noting that, in conventional systems, one typical payment option at check-out involves the consumer supplying the primary account number (PAN), expiration data, and card security code (CSC) to the merchant. The CSC is also referred to as Card Verification Data (CVD), a Card Verification Value (CVV or CVV2), a Card Verification Value Code (CVVC), a Card Verification Code (CVC or CVC2), a Verification Code (V-Code or V Code), or a Card Code Verification (CCV). These are all different terms for security features for credit or debit card transactions, providing increased protection for the merchants against credit card fraud.

However, as noted, in one or more embodiments of the invention, instead of the consumer providing his or her card details to the merchant, the merchant gives the merchant's “credit only” card account number (e.g., primary account number or “PAN”) to the consumer together with the amount of the order and a reference number for the particular purchase, as seen at 414 (e.g., via Internet 402). The reference number is usable in a manner analogous to a remittance advice so that the merchant, when receiving payment, is able to link the payment (e.g., the checkout or shopping basket) with the corresponding purchase details. In one or more embodiments, the reference number is provided together with a message to the merchant indicating a guarantee of payment 418 discussed below; a subsequent clearance message may then be provided, for example, with a link to the original guarantee or payment.

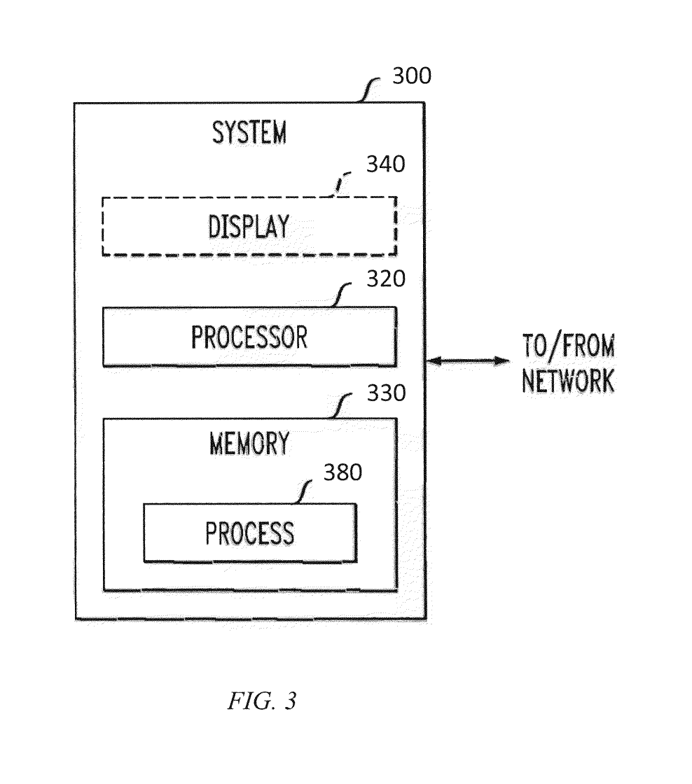

Step 414 can be carried out by having a server of merchant 406 serve HTML code to a browser on a machine such as machine 300 of consumer 404 (see discussion of FIG. 3 below).

As seen at solid lines 416, in a non-limiting example, the consumer 404 then logs into his or her bank 408 over Internet 402 (using, the bank's website accessed by a web browser, a desktop application, a smart phone application, or the like) and approves the purchase with the above details. This can be handled in many different ways besides the exemplary Internet communication; all that is required is an instruction to the bank that specifies the amount to be transferred, the aforementioned reference number, and the account number of the “credit only” account. Thus, this can also be done via a telephone call center, a text message, or even an in-person visit, and the like, as suggested by the dotted line 416 linking consumer 404 and bank 408.

The funds for the purchase may come, for example, from the consumer's payment card account. In some instances, the funds may come from a normal deposit account of the consumer. For example, this would occur inherently when the consumer's payment card is a debit card; in another approach, a database could be maintained to link the consumer's payment card account number to a deposit account. Bank 408 is typically the issuer of the consumer's payment card.

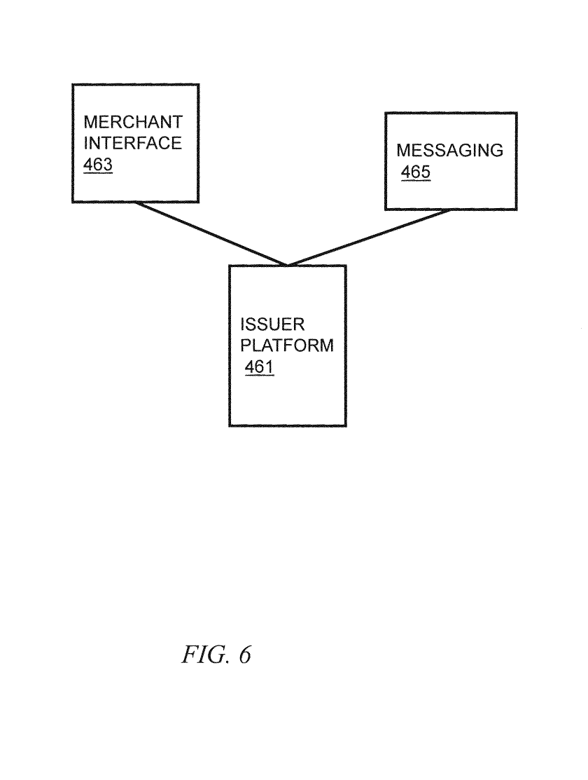

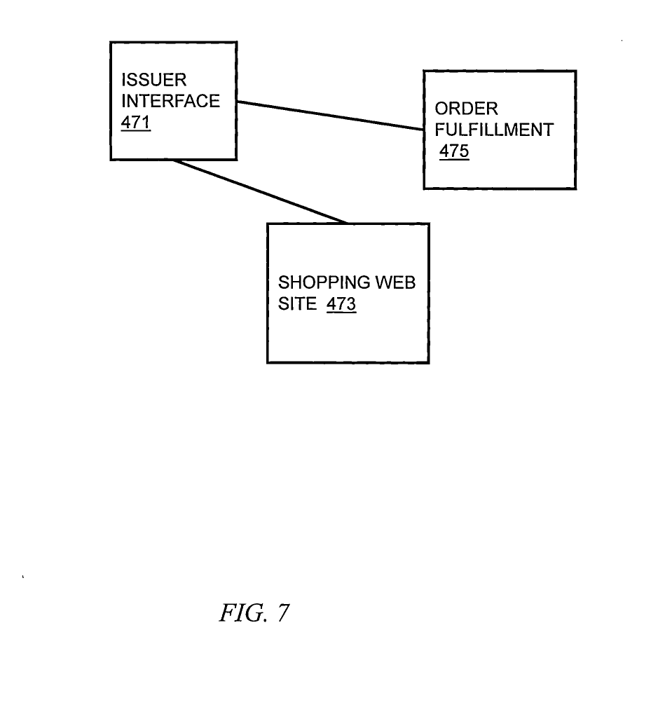

With regard to activities required to set up the solution in one or more embodiments, the consumer optionally downloads a small “app” to his or her smart phone or the like where this avenue is to be employed for messaging 416. One or more embodiments involve a pre-registration process where one or more merchants enroll in the solution. The banks 408, 410 implement appropriate functionality to recognize the various messages. The merchant will integrate with the merchant's bank, typically via a software interface (see FIGS. 6 and 7); the bank accesses payment network 2008 or the like on behalf of the merchant. The software interface between the bank and the merchant allows the merchant to receive messages indicating that the guarantee 418, discussed below, has been obtained from the consumer for the basket associated with the given reference number.

It is worth noting at this point that in one or more embodiments, nothing specific with regard to the purchase needs to be communicated to the consumer's bank 408 prior to the consumer approving the purchase; the consumer simply supplies the bank with the reference number, amount, and account number of the merchant's ‘credit only” card account.

Upon approval by the consumer, the consumer's bank 408 sends a payment guarantee to the merchant's bank 410 via payment network 2008 or the like, as seen at 418. The merchant's bank 410 is the same as the issuer of the merchant's card. This is passed on to the merchant as seen by the continuation of the payment guarantee message indicated by arrow 418 between issuer 410 and merchant 406, but reformatting by issuer 410 may occur in one or more embodiments.

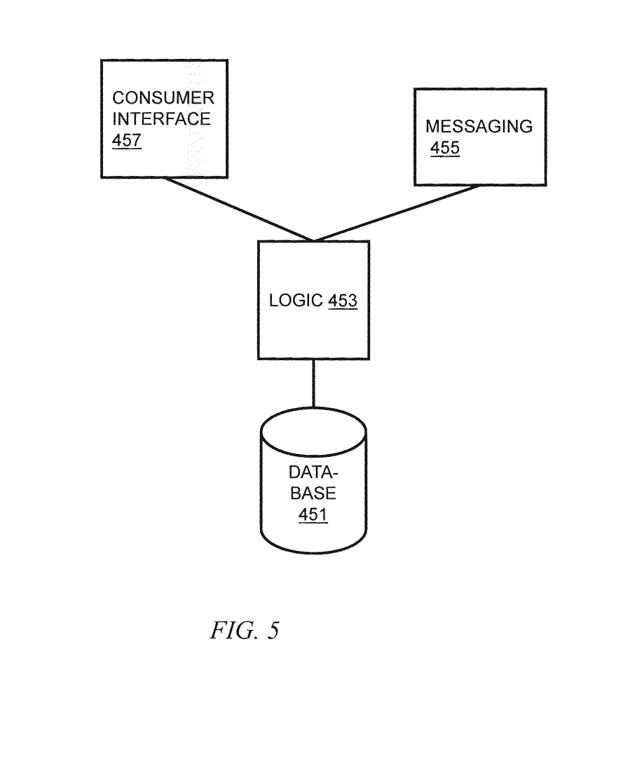

Referring now also to FIGS. 3 and 5, in one or more embodiments, the consumer's bank may have one or more servers such as 300 with a database 451, logic module 453, messaging module 455, and consumer interface module 457. Module 457 receives the message 416 form the consumer and parses same. Logic module 453 checks in database 451 to verify that the consumer has an account with adequate funding.

Messaging module 455 prepares and formats the massages to be sent over network 2008. Optionally, a special-purpose hardware box such as a MasterCard Interface Processor or MIP is interposed between the server of the bank 408 and the network 2008.

Several different non-limiting exemplary scenarios will now be presented. In one scenario, a dual message model is employed. An “auth request” is sent (ISO-8583 message 0100 with Transaction Type (DE3sf1)=“28” (Payment Transaction)) from the consumer's bank to the merchant's bank 410, over network 2008. This guarantees the money transfer (reserves funds for the merchant). Subsequently (for example, in one day) a “First Presentment” message 1240 is sent in a bulk file which completes the transfer.

In another scenario, a single message model is utilized. A Financial Transaction request is sent (ISO-8583 message 0200 with Transaction Type (DE3sf1)=“28” (Payment Transaction)) from the consumer's bank to the merchant's bank 410 via the payment network 2008.

Payment network 2008 is of the kind connecting multiple issuers with multiple acquirers and using ISO 8583 messages. However, as noted above in the discussion of FIG. 2, other kinds of payment networks can be employed in other embodiments.

It is worth noting at this point that ISO 8583 message type 0100 is used in a conventional transaction as an authorization request from the acquirer 2006 to the issuer 2010 of the consumer's card, to which the issuer 2010 responds with an authorization request response 0110. The message type 0100 is also utilized conventionally for chargebacks and the like. The message type 0100 is utilized in a different way here based on a different code/transaction type than in the conventional applications (Transaction Type (DE3sf1)=“28” (Payment Transaction)).

In either scenario, the Issuer bank 410 notifies the merchant 406 (for example, via the aforementioned software interface 463, 471 discussed below) about the payment guarantee received (together with the reference number). This is suggested by the line labeled 418 connecting the issuer 410 and merchant 406. The software interface can, in at least some instances, use different messages than the ISO 8583 messages; the format of same may be agreed upon between the merchant 406 and issuer 410. The merchant 406 verifies the payment and completes the purchase; when the funds are guaranteed, the merchant will dispatch the goods, as seen at 420.

As seen in FIG. 6, and still referring to FIGS. 3 and 4, in one or more embodiments, the issuer 410 may have one or more servers such as 300 with a suitable issuer platform module 461, a messaging module 465 similar to module 455, and a merchant interface module 463 (such interface could be as simple as e-mail messaging or could involve detailed integration between the issuer platform of the issuer 410 and the shopping web site and/or order fulfillment modules of merchant 406). Again, optionally, a special-purpose hardware box such as a MasterCard Interface Processor or MIP is interposed between the server of the issuer 410 and the network 2008. As seen in FIG. 7, and still referring to FIGS. 3, 4 and 6, the merchant 406 may have one or more servers such as 300 with a suitable interface module 471 to the issuer 410 (as noted, such interface could be as simple as e-mail messaging or could involve detailed integration between the issuer platform of the issuer 410 and the shopping web site and/or order fulfillment modules of merchant 406); a module 473 to maintain the shopping web site (which serves HTML code to consumer 404 as described), and an order fulfillment module 475 which alerts appropriate shipping/warehouse crew or the like to make a shipment once the payment guarantee 418 is received.

Since the consumer's bank 408 is the issuer of the consumer's payment card and/or the institution where the consumer maintains his or her bank account, the consumer's bank knows whether the consumer has adequate money and/or credit line to make good on the payment guarantee. Of course, more sophisticated approaches are possible. For example, bank 408 could offer the payment technique as a service and access another source of funds of the consumer 404 (for example, a payment card account of consumer 404 from an issuer other than bank 408, in which case bank 408 might initiate a conventional authorization request and response message as described with regard to FIG. 2, with the bank 408 acting as a merchant/acquirer and communicating via network 2008 with the issuer of this alternative payment card of the consumer 404).

Upon conclusion of the process, goods and money change hands, but merchants and consumers are no longer exposed to the risks mentioned above. Advantageously, since money transfer is carried out between card accounts, one or more embodiments can re-use existing infrastructure for card payments.

One or more instances reduce risks for the consumer because he or she does not reveal his or her card details to the merchant at all. Thus, the risk that the merchant will abuse same is substantially reduced or eliminated.

One or more instances also reduce risks for the merchant because, when a merchant has received a payment guarantee 418 from the consumer's bank 408, the merchant is guaranteed that the consumer has sufficient funds in his or her account, and that the consumer personally authorized the transaction, which was verified by the consumer's bank 408 and cannot later be repudiated by the consumer.

One or more embodiments thus involve two pertinent aspects, namely, (i) the concept of paying for Internet commerce transactions or the like by having the consumer transfer money into a special credit only card account of the merchant, which protects the consumer from divulging his or her payment card details; and (ii) the concept that the special credit only card account has an account number that the merchant can safely give to consumers because only credits to the merchant's account can be effectuated with that account number.

Given the discussion thus far, it will be appreciated that, in general terms, an exemplary method, from the perspective of the merchant 406, includes the step of obtaining, at a server of a merchant, an indication that a consumer 404 wishes to check-out in connection with an on-line purchase of goods. This step could be carried out, for example, by the shopping web site module 473 executing on at least one hardware processor of a merchant's server. A further step 414 includes, responsive to obtaining the indication, sending to the consumer a total transaction amount, a credit-only payment card account number of the merchant, and a reference number assigned to the on-line purchase of goods. This step could be carried out, for example, by the shopping web site module 473 executing on the at least one hardware processor of the merchant's server. A still further step 418 includes obtaining, at the server of the merchant, from a bank 410 of the merchant which issues the credit-only payment card account, a guarantee that the consumer will cause the total transaction amount to be credited to the credit-only payment card account number of the merchant. The guarantee is associated with the reference number. This step could be carried out, for example, by the issuer interface module 471 executing on the at least one hardware processor of the merchant's server. A still further step includes, responsive to obtaining the guarantee, shipping the goods to the consumer. This step can be initiated by a message generated by the order fulfillment module executing on the at least one hardware processor.

Furthermore, given the discussion thus far, it will be appreciated that, in general terms, another exemplary method, from the perspective of the consumer 404, includes the step of, responsive to the consumer wishing to check-out in connection with an on-line purchase of goods from a merchant 406, receiving, at a computing device of the consumer, from the merchant, a total transaction amount, a credit-only payment card account number of the merchant, and a reference number assigned to the on-line purchase of goods. A further step 416 includes dispatching, from the consumer, to a server of a bank 408 of the consumer, an approval of payment to the merchant for the on-line purchase of goods, based on the total transaction amount, the credit-only payment card account number of the merchant, and the reference number assigned to the on-line purchase of goods.

In some cases, the receiving step includes receiving hypertext markup language code displayed by a browser software module executing on at least one hardware processor of the computing device of the consumer.

In some cases, in the dispatching step, the approval is dispatched from the computing device of the consumer (in other cases, an alternative approach is used as described with respect to the dotted line 416).

In some cases, the computing device is a smart phone and the dispatching includes executing a downloadable application on at least one hardware processor of the smart phone.

Yet further, given the discussion thus far, it will be appreciated that, in general terms, still another exemplary method, from the perspective of the issuer 410 of the merchant's card, includes the step 412 of assigning to a merchant 406 an account number of a credit-only payment card account. This step can be carried out, for example, by the issuer platform module 461 executing on at least one hardware processor of an issuer server. A further step 418 includes obtaining, from a consumer's bank 408, a guarantee that the consumer will cause a total transaction amount of an on-line transaction to be credited to the credit-only payment card account number of the merchant. The guarantee is associated with a reference number of the on-line transaction. This step can be carried out, for example, by the messaging module 465 executing on the at least one hardware processor of the issuer server. An even further step includes dispatching the guarantee to the merchant. This step can be carried out, for example, by the merchant interface module 463 executing on the at least one hardware processor.

In some cases, a further method step includes reformatting the guarantee prior to dispatching the guarantee to the merchant (e.g., fro ISO 8583 to a proprietary format agreed to by the issuer 410 and merchant 406).

In some cases, further method steps include intercepting an attempt to debit the credit-only payment card account; and preventing the attempt to debit the credit-only payment card account, based on credit-only status of the credit-only payment card account. For example, the credit-only payment card account number can be compared to a list stored in a database by suitable logic executing on a server of the issuer, to determine if it in fact corresponds to a special credit-only payment card account (for example, via hashing techniques or the like).

As noted, the above-mentioned guarantee can be, for example, an ISO-8583 message type 0100 with transaction type twenty eight, or an ISO-8583 message type 0200 with transaction type twenty eight.

Even further, given the discussion thus far, it will be appreciated that, in general terms, an additional exemplary method, from the perspective of an operator of payment network 2008, includes the steps of providing to an issuing bank 410 at least one payment card account number specially designated for association with a credit-only payment card account; intercepting a message sent over a payment processing network, such as 2008 or the like, which attempts to debit an account associated with the credit-only payment card account number; and preventing the attempt to debit the account associated with the credit-only payment card account number, based on credit-only status of the credit-only payment card account. The intercepting step could be carried out, for example, by comparing the credit-only payment card account number to a list stored in a database by suitable logic executing on a server of the payment network operator, to determine if it in fact corresponds to a special credit-only payment card account (for example, via hashing techniques or the like). Prevention could involve responding to an authorization or other request with a denial message or the like; for example, again via suitable logic executing on a server of the payment network operator.

In some instances one or more issuing banks may request the numbers from the payment network operator.

In another aspect, a merchant server includes a memory 330, and at least one processor 320, coupled to the memory, and operative to carry out or otherwise facilitate performance of any one, some, or all of the method steps described from the perspective of the merchant. The merchant server may trigger shipping of the goods to the consumer. The merchant server may further include a plurality of distinct software modules embodied in a non-transitory manner on a computer-readable storage medium, such as any one or more of those shown in FIG. 7.

In yet another aspect, an issuer server includes a memory 330, and at least one processor 320, coupled to the memory, and operative to carry out or otherwise facilitate performance of any one, some, or all of the method steps described from the perspective of the issuer 410. The issuer server may further include a plurality of distinct software modules embodied in a non-transitory manner on a computer-readable storage medium, such as any one or more of those shown in FIG. 6.

### System and Article of Manufacture Details

Embodiments of the invention can employ hardware and/or hardware and software aspects. Software includes but is not limited to firmware, resident software, microcode, etc. Software might be employed, for example, in connection with one or more of a terminal 122, 124, 125, 126; a reader 132; payment devices such as cards 102, 112; a host, server or other computing device 300, and/or processing center 140, 142, 144 (optionally with data warehouse 154) of a merchant, issuer, acquirer, processor, or operator of a network 2008 operating according to a payment system standard (and/or specification), as well as any one, some, or all of the modules shown in FIGS. 5-7. Firmware might be employed, for example, in connection with payment devices such as cards 102, 112 and reader 132. Firmware provides a number of basic functions (e.g., display, print, accept keystrokes) that in themselves do not provide the final end-use application, but rather are building blocks; software links the building blocks together to deliver a usable solution.

FIG. 3 is a block diagram of a system 300 that can implement part or all of one or more aspects or processes of the invention. As shown in FIG. 3, memory 330 configures the processor 320 (which could correspond, e.g., to processor portions 106, 116, 130; processors of remote hosts in centers 140, 142, 144; processors of servers implementing blocks 406, 408, 410; a processor of a computing device of consumer 404, and the like) to implement one or more aspects of the methods, steps, and functions disclosed herein (collectively, shown as process 380 in FIG. 3). Different method steps can be performed by different processors. The memory 330 could be distributed or local and the processor 320 could be distributed or singular. The memory 330 could be implemented as an electrical, magnetic or optical memory, or any combination of these or other types of storage devices (including memory portions as described above with respect to cards 102, 112; memories of one or more servers or other general purpose computers as described with respect to FIGS. 4-7; smart phone of a consumer 404, and the like. It should be noted that if distributed processors are employed, each distributed processor that makes up processor 320 generally contains its own addressable memory space. It should also be noted that some or all of computer system 300 can be incorporated into an application-specific or general-use integrated circuit. For example, one or more method steps could be implemented in hardware in an ASIC rather than using firmware. Display 340 is representative of a variety of possible input/output devices (e.g., displays, mice, keyboards, and the like).

The notation “to/from network” is indicative of a variety of possible network interface devices.

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is defined to encompass a non-transitory recordable medium, examples of which are set forth above, but does not encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on elements 140, 142, 144, 406, 408, 410, 2004, 2006, 2008, 2010, computing device of a consumer 404 (e.g., desktop, laptop, smart phone, or the like) or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, any of the modules or blocks discussed with respect to FIGS. 1-2 and 4-7, can make use of computer technology with appropriate instructions to implement method steps described herein. The various platforms can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 300 as shown in FIG. 3) running a server program. It will be understood that such a physical server may or may not include a display, keyboard, or other input/output components. A “host” includes a physical data processing system (for example, system 300 as shown in FIG. 3) running an appropriate program. It will be understood that such a host may or may not include a display, keyboard, or other input/output components.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. In one or more embodiments, the modules include the modules shown in FIGS. 5-7. The method steps can then be carried out using the distinct software modules and/or sub-modules of the system, as described above, executing on one or more hardware processors 320. Further, a computer program product can include a computer-readable storage medium with code adapted to be implemented to carry out one or more method steps described herein, including the provision of the system with the distinct software modules.

Computers discussed herein can be interconnected, for example, by one or more of network 138, 2008, another virtual private network (VPN), the Internet 402, a local area and/or wide area network (LAN and/or WAN), and so on. The computers can be programmed, for example, in compiled, interpreted, object-oriented, assembly, and/or machine languages, for example, one or more of C, C++, Java, Visual Basic, JavaScript or other ECMAScript based scripting languages, and the like (an exemplary and non-limiting list), and can also make use of, for example, Extensible Markup Language (XML), JSON, name/value pairs, known application programs such as relational database applications, and the like. The computers can be programmed to implement the logic depicted in the flow charts and other figures. At least some messages, in at least some instances, can be in accordance with ISO 8583.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
obtaining, at a server of a merchant, an indication that a consumer wishes to check-out in connection with an on-line purchase of goods;
responsive to obtaining said indication, sending to said consumer a total transaction amount, a credit-only payment card account number of said merchant, and a reference number assigned to said on-line purchase of goods;
obtaining, at said server of said merchant, from a bank of said merchant which issues said credit-only payment card account, a guarantee that said consumer will cause said total transaction amount to be credited to said credit-only payment card account number of said merchant, said guarantee being associated with said reference number; and
responsive to obtaining said guarantee, shipping said goods to said consumer.

2. The method of claim 1, further comprising providing a system, wherein the system comprises distinct software modules, each of the distinct software modules being tangibly embodied in a non-transitory manner on a computer-readable storage medium, and wherein the distinct software modules comprise a shopping web site module and an issuer interface module;
wherein:
said obtaining of said indication is carried out by said shopping web site module executing on at least one hardware processor;
said sending of said total transaction amount, said credit-only payment card account number of said merchant, and said reference number is carried out by said shopping web site module executing on said at least one hardware processor; and
said obtaining of said guarantee is carried out by said issuer interface module executing on said at least one hardware processor.

3. The method of claim 2, wherein the distinct software modules further comprise an order fulfillment module, and wherein said shipping of said goods is initiated by a message generated by said order fulfillment module executing on said at least one hardware processor.

4. A method comprising the steps of:
responsive to a consumer wishing to check-out in connection with an on-line purchase of goods from a merchant, receiving, at a computing device of said consumer, from said merchant, a total transaction amount, a credit-only payment card account number of said merchant, and a reference number assigned to said on-line purchase of goods; and
dispatching, from said consumer, to a server of a bank of said consumer, an approval of payment to said merchant for said on-line purchase of goods, based on said total transaction amount, said credit-only payment card account number of said merchant, and said reference number assigned to said on-line purchase of goods.

5. The method of claim 4, further comprising providing a browser software module tangibly embodied in a non-transitory manner on a computer-readable storage medium, wherein said receiving step comprises receiving hypertext markup language code displayed by said browser module executing on at least one hardware processor of said computing device of said consumer.

6. The method of claim 4, wherein, in said dispatching step, said approval is dispatched from said computing device of said consumer.

7. The method of claim 6, wherein said computing device comprises a smart phone and wherein said dispatching comprises executing a downloadable application on at least one hardware processor of said smart phone.

8. A method comprising the steps of:
assigning to a merchant an account number of a credit-only payment card account;
obtaining, from a consumer's bank, a guarantee that said consumer will cause a total transaction amount of an on-line transaction to be credited to said credit-only payment card account number of said merchant, said guarantee being associated with a reference number of said on-line transaction; and
dispatching said guarantee to said merchant.

9. The method of claim 8, further comprising reformatting said guarantee prior to dispatching said guarantee to said merchant.

10. The method of claim 8, further comprising:
intercepting an attempt to debit said credit-only payment card account; and
preventing said attempt to debit said credit-only payment card account, based on credit-only status of said credit-only payment card account.

11. The method of claim 8, wherein, in said obtaining step, said guarantee comprises an ISO-8583 message type 0100 with transaction type twenty eight.

12. The method of claim 8, wherein, in said obtaining step, said guarantee comprises an ISO-8583 message type 0200 with transaction type twenty eight.

13. The method of claim 8, further comprising providing a system, wherein the system comprises distinct software modules, each of the distinct software modules being tangibly embodied in a non-transitory manner on a computer-readable storage medium, and wherein the distinct software modules comprise an issuer platform module, a messaging module, and a merchant interface module;
wherein:
said assigning of said account number is carried out by said issuer platform module executing on at least one hardware processor;
said obtaining of said guarantee is carried out by said messaging module executing on said at least one hardware processor; and
said dispatching of said guarantee is carried out by said merchant interface module executing on said at least one hardware processor.

14. A method comprising the steps of:
providing to an issuing bank at least one payment card account number specially designated for association with a credit-only payment card account;
intercepting a message sent over a payment processing network which attempts to debit an account associated with said credit-only payment card account number; and
preventing said attempt to debit said account associated with said credit-only payment card account number, based on credit-only status of said credit-only payment card account.

15. A merchant server comprising:
a memory; and
at least one processor, coupled to said memory, and operative to:
obtain, at said merchant server, an indication that a consumer wishes to check-out in connection with an on-line purchase of goods;
responsive to obtaining said indication, send to said consumer a total transaction amount, a credit-only payment card account number of said merchant, and a reference number assigned to said on-line purchase of goods;
obtain, at said merchant server, from a bank of said merchant which issues said credit-only payment card account, a guarantee that said consumer will cause said total transaction amount to be credited to said credit-only payment card account number of said merchant, said guarantee being associated with said reference number; and
responsive to obtaining said guarantee, trigger shipping of said goods to said consumer.

16. The merchant server of claim 15, further comprising a plurality of distinct software modules embodied in a non-transitory manner on a computer-readable storage medium, and wherein the distinct software modules comprise a shopping web site module and an issuer interface module;
wherein:
said at least one processor is operative to obtain said indication by executing said shopping web site module;
said at least one processor is operative to send said total transaction amount, said credit-only payment card account number of said merchant, and said reference number by executing said shopping web site module; and
said at least one processor is operative to obtain said guarantee by executing said issuer interface module.

17. The merchant server of claim 16, wherein the distinct software modules embodied on the computer-readable storage medium further comprise an order fulfillment module, and wherein said at least one processor is operative to trigger said shipping of said goods with said message by executing said order fulfillment module.

18. An apparatus comprising:
means for obtaining, at a server of a merchant, an indication that a consumer wishes to check-out in connection with an on-line purchase of goods;
means, responsive to obtaining said indication, for sending to said consumer a total transaction amount, a credit-only payment card account number of said merchant, and a reference number assigned to said on-line purchase of goods;
means for obtaining, at said server of said merchant, from a bank of said merchant which issues said credit-only payment card account, a guarantee that said consumer will cause said total transaction amount to be credited to said credit-only payment card account number of said merchant, said guarantee being associated with said reference number; and
means, responsive to obtaining said guarantee, for triggering shipping of said goods to said consumer.

19. A computer program product comprising a computer readable storage medium having computer readable program code embodied therewith, said computer readable program code comprising:
computer readable program code configured to obtain, at a merchant server, an indication that a consumer wishes to check-out in connection with an on-line purchase of goods;
computer readable program code configured to, responsive to obtaining said indication, send to said consumer a total transaction amount, a credit-only payment card account number of said merchant, and a reference number assigned to said on-line purchase of goods;
computer readable program code configured to obtain, at said merchant server, from a bank of said merchant which issues said credit-only payment card account, a guarantee that said consumer will cause said total transaction amount to be credited to said credit-only payment card account number of said merchant, said guarantee being associated with said reference number; and
computer readable program code configured to, responsive to obtaining said guarantee, trigger shipping of said goods to said consumer.

20. An issuer server comprising:
a memory; and
at least one processor, coupled to said memory, and operative to:
assign to a merchant an account number of a credit-only payment card account;
obtain, from a consumer's bank, a guarantee that said consumer will cause a total transaction amount of an on-line transaction to be credited to said credit-only payment card account number of said merchant, said guarantee being associated with a reference number of said on-line transaction; and
dispatch said guarantee to said merchant.

21. The issuer server of claim 20, wherein said at least one processor is further operative to reformat said guarantee prior to dispatching said guarantee to said merchant.

22. The issuer server of claim 20, wherein said at least one processor is further operative to:
intercept an attempt to debit said credit-only payment card account; and
prevent said attempt to debit said credit-only payment card account, based on credit-only status of said credit-only payment card account.

23. The issuer server of claim 20, wherein said at least one processor is operative to obtain said guarantee as an ISO-8583 message type 0100 with transaction type twenty eight.

24. The issuer server of claim 20, wherein said at least one processor is operative to obtain said guarantee as an ISO-8583 message type 0200 with transaction type twenty eight.

25. The issuer server of claim 20, further comprising a plurality of distinct software modules embodied in a non-transitory manner on a computer-readable storage medium, and wherein the distinct software modules comprise an issuer platform module, a messaging module, and a merchant interface module;
wherein:
said at least one processor is operative to assign said account number by executing said issuer platform module;
said at least one processor is operative to obtain said guarantee by executing said messaging module; and
said at least one processor is operative to dispatch said guarantee by executing said merchant interface module.

26. A computer program product comprising a computer readable storage medium having computer readable program code embodied therewith, said computer readable program code comprising:
computer readable program code configured to assign to a merchant an account number of a credit-only payment card account;
computer readable program code configured to obtain, from a consumer's bank, a guarantee that said consumer will cause a total transaction amount of an on-line transaction to be credited to said credit-only payment card account number of said merchant, said guarantee being associated with a reference number of said on-line transaction; and
computer readable program code configured to dispatch said guarantee to said merchant.

27. An apparatus comprising:
means for assigning to a merchant an account number of a credit-only payment card account;
means for obtaining, from a consumer's bank, a guarantee that said consumer will cause a total transaction amount of an on-line transaction to be credited to said credit-only payment card account number of said merchant, said guarantee being associated with a reference number of said on-line transaction; and
means for dispatching said guarantee to said merchant.
